(19) United States
(12) Patent Application Publication
(10) Pub. No.: US 2018/0101794 A1
(43) Pub. Date: Apr. 12, 2018

(54) METHOD AND SYSTEM FOR CREATING MAPPING BETWEEN BUSINESS MODELS

(71) Applicant: INTERNATIONAL BUSINESS MACHINES CORPORATION, ARMONK, NY (US)

(72) Inventors: Liam Harpur, Dublin (IE); Niall Jordan, Tenure (IE); Bryan Kingston, Rosscarbery (IE)

(21) Appl. No.: 15/837,080

(22) Filed: Dec. 11, 2017

Related U.S. Application Data
(63) Continuation of application No. 15/245,510, filed on Aug. 24, 2016.

(51) Int. Cl. G06Q 10/06

(52) U.S. Cl. CPC G06Q 10/067; G06Q 10/0637

(57) ABSTRACT

Embodiments of the present invention disclose a method, computer program product, and system for updating business model mappings. A computer receives a plurality of business models and a plurality of model mappings, wherein the plurality of model mappings show how elements of one of the plurality of business models relates to another element of another of the plurality of business models. The computer determines that information contained within at least one of the plurality of business models has been changed and determines how the changed information contained within the at least one of the plurality of business models affects at least one model mapping of the plurality of model mappings. The computer updates the model mapping to reflect the updated, changed, or altered information of the at least one of the plurality of business models.

### BACKGROUND

The present invention relates generally to the field of organizing and inter-relating data files, and more particularly to database, schema, or data structures created, modified or populated using a formal language supported by a database management system.

There is a requirement for business analysis and design modeling to be less manual and laborious, and more agile and automated in nature. The process for mapping one business model to another begins with analyzing and understanding the content of both models, and any existing mappings between them. Then the mappings are updated or added to based on any missing mappings identified by the analyst. A problem in the mapping process is the way that changes to one model are absorbed and propagated to the mappings between the models. The current manual process requires understanding of the as-is situation, determination of the to-be situation, and manual tasks to update the models and the mappings between them.

### BRIEF SUMMARY

Additional aspects and/or advantages will be set forth in part in the description which follows, and, in part, will be apparent from the description, or may be learned by practice of the invention.

Embodiments of the present invention disclose a method, computer program product, and system for updating business model mappings. A computer receives a plurality of business models and a plurality of model mappings, wherein the plurality of model mappings show how elements of one of the plurality of business models relates to another element of another of the plurality of business models. The computer determines that information contained within at least one of the plurality of business models has been changed and determines how the changed information contained within the at least one of the plurality of business models affects at least one model mapping of the plurality of model mappings. The computer updates the model mapping to reflect the updated, changed, or altered information of the least one of the plurality of business models.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating a business model mapping processing environment, in accordance with an embodiment of the present invention.

FIG. 2 is a flowchart depicting operational steps of the business model mapping processing environment of FIG. 1, in accordance with an embodiment of the present invention.

FIG. 3 is a flowchart depicting operational steps of the business model mapping processing environment of FIG. 1, in accordance with an embodiment of the present invention.

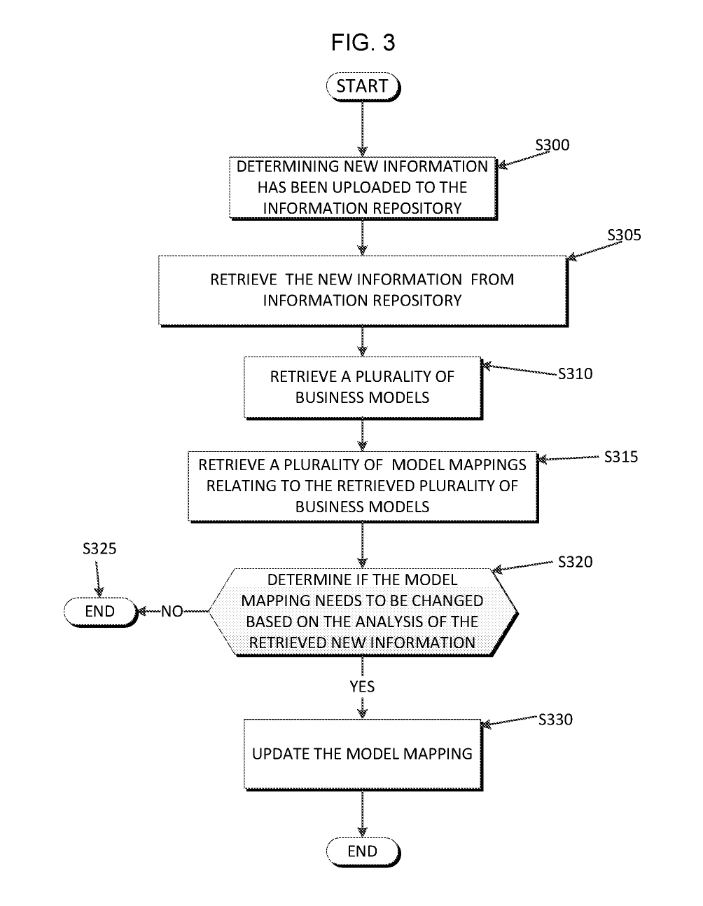

FIG. 4 is a block diagram of components of a computing device of the business model mapping processing environment of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for creating, updating, and maintaining model mapping between a plurality of different business models. The system retrieves the business models and determines if a change has occurred in at least one of the business model. Once a change has been determine, the system retrieves the model mapping, i.e. how one business model relates to another business model, and determines the effect of the change to the business to the model mapping. The system determines the effect by retrieving information from the information repository, which contains emails, memo, meeting notes, and other information, that refers to the business models. The system reviews the retrieved information to determine effect of the change to the business model to model mapping and updates the model mapping accordingly.

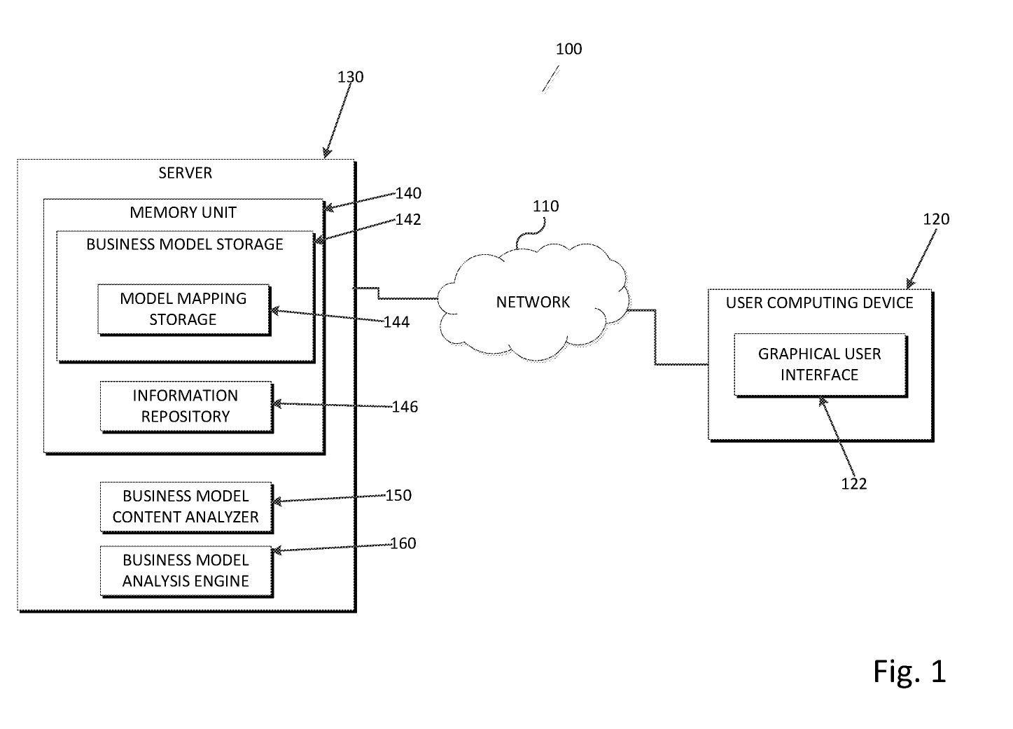

FIG. 1 is a functional block diagram illustrating a business model mapping processing environment 100, in accordance with an embodiment of the present invention. The business model processing environment includes a user computing device 120 and a server 130 that communicate via network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between the user computing device 120, and server 130, in accordance with one or more embodiments of the invention.

The user computing device 120 represents a computing device that includes a user interface, for example, a graphical user interface 122. The graphical user interface 122 can be any type of application that is run on the server 130, for example, the application can be a web application, a graphical application, an editing application or any other type of application/program that allows a user to upload, change, delete, alter, or update a business model to server 130.

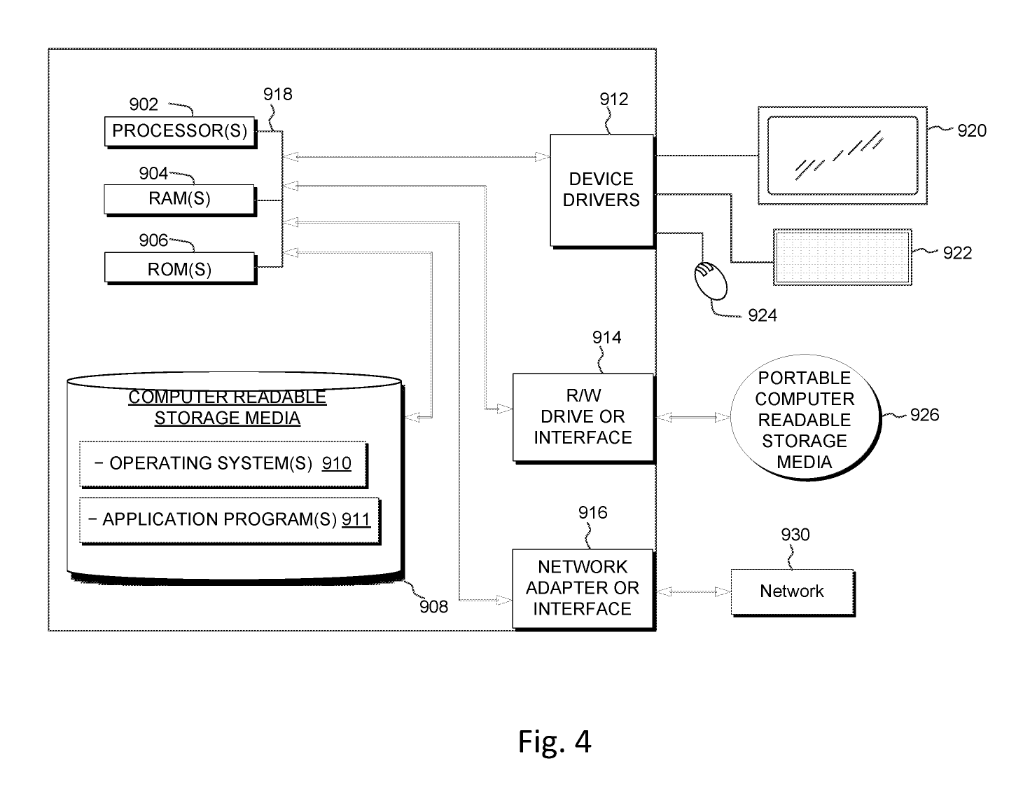

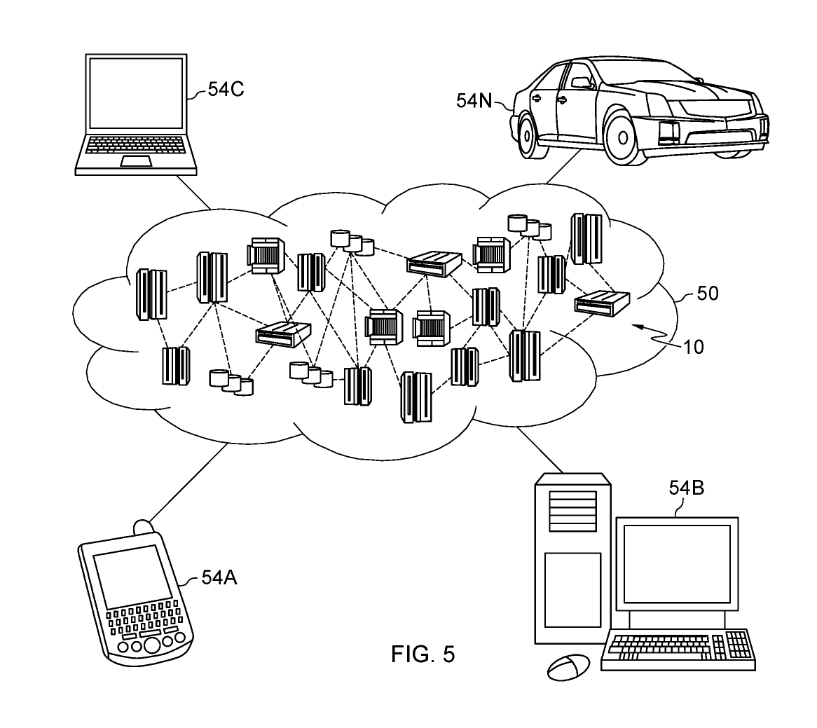

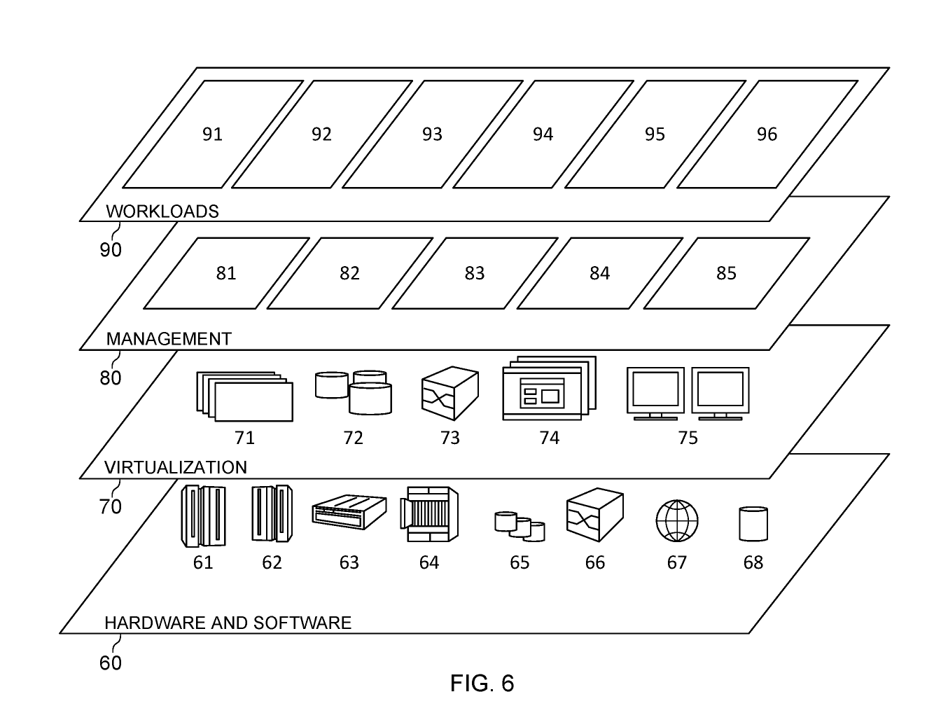

The user computing device 120 may be any type of computing devices that are capable of connecting to network 110, for example, a laptop computer, tablet computer, netbook computer, personal computer (PC), a desktop computer, a smart phone, or any programmable electronic device supporting the functionality required by one or more embodiments of the invention. The user computing device 120 may include internal and external hardware components, as described in further detail below with respect to FIG. 4. In other embodiments, the server 130 may operate in a cloud computing environment, as described in further detail below with respect to FIGS. 5 and 6.

The server 130 includes a memory unit 140, a business model content analyzer 150, and a business model analysis engine 160. The server 130 is able to communicate with the user computing device 120, via network 110. Server 130 may include internal and external hardware components, as depicted and described in further detail below with reference to FIG. 4. In other embodiments, computing device 120 may include internal and external hardware components, as depicted and described in further detail below with respect to FIG. 5, and operate in a cloud computing environment, as depicted in FIG. 6.

The memory unit 140 is a data store that stores the business models, model mappings, and information concerning the business models. The memory unit 140 includes a business model storage 142, a model mapping storage 144, and an information repository 146. The memory unit 140 may be a magnetic disk storage device of an internal hard drive, compact disc read-only memory (CD-ROM), digital versatile disk (DVD), memory stick, magnetic tape, magnetic disk, optical disk, a semiconductor storage device such as random access memory (RAM), read-only memory (ROM), erasable programmable read-only memory (EPROM), flash memory or any other computer-readable tangible storage device that can store a computer program and digital information.

The business model storage 142 is a data store that contains the model mapping storage 144. The business model storage 142 is a repository of the different business models that a user has uploaded to the server 130 from the user computing device 120. The business model storage 142 stores a plurality of different business model, reference versions of the business models, updates to the business models, and information how the different business models are mapped or related to each other. The reference versions of the business models are updated after model updating procedure steps occurs. The model mapping storage 144 stores the information as to how the different business models are related or mapped to each other.

The memory unit 140 further includes an information repository 146. The information repository 146 is a data store that contain any information that created by the business that might discuss or contain information about any business model. The information repository contains all communication content has the potential to be used to identify the relationship between business model elements. The communications can be, for example, emails, instant message chats, transcribed meeting notes, or any other type of textual communication (or communication that can be converted to a text format) where the business models are discussed.

The business model content analyzer 150 identifies the type of update i.e. an existing element has been updated or a new element has been added. The business model content analyzer 150 compares the current business model with the stored reference version of the business model to determine if the business model has been changed/altered. When the business model has been changed then the business model content analyzer 150 identifies the changed/altered material of the business model or business model content analyzer 150 identifies any material that was added to the business model.

The business model analysis engine 160 determines how the change/altered material of the business model or the newly added material affects the mapping of the business to the other stored business models. The business model analysis engine 160 retrieves any information, for example, possible labels contained within the information repository 146 that might be related to changed/altered material of the business model or the newly added material. The business model analysis engine 160 determines attributes by the content of the information repository 146 and the labels associated with the entries in the information repository 156. The labels may simply be the same as the text of the term in that entry, or may be different, e.g. the term “Mortgage” may have labels for “Mortgage” and “Loan” or “Term Loan.” The business model analysis engine determines a proximate score based on the changed/altered material of the business model or the newly added material to the business model, and the retrieved information from the information repository 146. The proximate score identifies and filters words or characteristics that are closely related to one another that have the potential to have a relationship between one another. The business model analysis engine 160 determines the relationship or mapping of the changed/altered material of the business model or the newly added material to the business model to the other stored business models based on the proximate score, the information retrieved from the information repository 146. The business model analysis engine 160 updates the mapping information stored in model mapping storage 144.

The business model analysis engine 160 further determines when new information or data has been uploaded to the information repository 146. When the business model analysis engine 160 determines new information or data has been uploaded to the information repository 146, then the business model analysis engine 160 determines if the plurality of model mappings stored in the model mapping storage 144 need to be updated based off the new information.

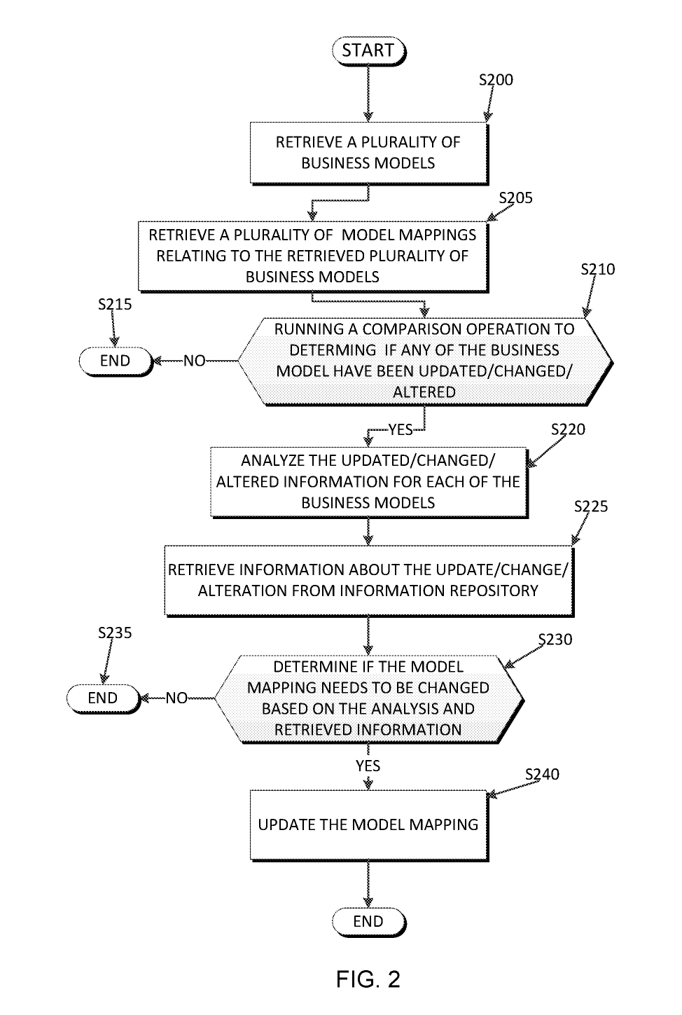

FIG. 2 is a flowchart depicting operational steps of the business model mapping processing environment 100 of FIG. 1, in accordance with an embodiment of the present invention.

The business model content analyzer 150 retrieves a current version of a plurality of business models from the business model storage 142 and retrieves a stored reference version for each of the plurality of business models from the business model storage 142 (S200). The business model content analyzer 150 retrieves a plurality of model mappings that relate to the retrieved plurality of business models (S205). The business model content analyzer 150 compares each of the retrieved current versions of the plurality of business models to its related reference version of the business model to determine if the current business model has been updated/changed/altered or had new information added (S210). When it is determined that there has been no change to any of the business models than the process is stopped (S215). When it has been determined that at least one of plurality of business models has been updated/changed/altered or had new material added then the business model analysis engine 160 analyzes the updated/changed/altered information to the business model or the new material added to the business model (S220). The business model analysis engine 160 retrieves information contained within the information repository 146 that is related to the updated/changed/altered information in the business model or the new material added to the business model (S225). The business model analysis engine 160 determines if the model mapping, for example, how the different portions of business model A relate to different portions of model B, need to be changed (S230). When it is determined that the model mapping does not need to be changed than the process is stopped (S235). When it is determined that the model mapping needs to be changed than the business model analysis engine 160 updates the model mapping stored in the model mapping storage 144 (S240).

The business model analysis engine 160 determines new information or data has been uploaded to the information repository 146 (S300). The business model analysis engine 160 retrieves the new information from the information repository 146 (S305). The business model content analyzer 150 retrieves a current version of a plurality of business models from the business model storage 142 (S310). The business model content analyzer 150 retrieves a plurality of model mappings that relate to the retrieved plurality of business models (S315). The business model analysis engine 160 determines if the model mapping, for example, how the different portions of business model A relate to different portions of model B, need to be changed based on the new information that was uploaded to the information repository 146 (S320). When it is determined that the model mapping does not need to be changed than the process is stopped (S325). When it is determined that the model mapping needs to be changed than the business model analysis engine 160 updates the model mapping stored in the model mapping storage 144 (S330).

FIG. 4 depicts a block diagram of components of server 130 of the business model mapping processing environment 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

User computing devices 120 and/or server 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, business model content analyzer 150 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

User computing devices 120 and/or server 130 may also include a R/W drive or interface 914 to read from and write to one or more portable computer readable storage media 926. Application programs 911 on user computing devices 120 and/or server 130 may be stored on one or more of the portable computer readable storage media 926, read via the respective R/W drive or interface 914 and loaded into the respective computer readable storage media 908.

User computing devices 120 and/or server 130 may also include a network adapter or interface 916, such as a Transmission Control Protocol(TCP)/Internet Protocol(IP) adapter card or wireless communication adapter (such as a 4G wireless communication adapter using Orthogonal Frequency Division Multiple Access (OFDMA) technology). Application programs 911 on user computing devices 120 and/or server 130 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

User computing devices 120 and/or server 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the business model mapping processing environment 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method comprising:
receiving, by a computer, a plurality of business models and a plurality of model mappings, wherein the plurality of model mappings show how elements of one of the plurality of business models relates to another element of another of the plurality of business models;
determining, by the computer, that information contained within at least one of the plurality of business models has been changed;
determining, by the computer, how the changed information contained within the at least one of the plurality of business models changes at least one model mapping of the plurality of model mappings, wherein the change in the at least one model mapping of the plurality of model mappings is how the changed information contained within the at least one of the plurality of business models will correspond to another of the plurality of business models; and
updating, by the computer, the model mappings to reflect the changed information of the least one of the plurality of business models.

2. The method of claim 1, further comprises:
receiving, by the computer, a reference version for each of the received plurality of business models.

3. The method of claim 2, wherein the determining, by the computer, that information contained within at least one of the plurality of business models has been changed, comprises:
comparing, by the computer, each of the received plurality of business models with its corresponding received reference version; and
wherein the changed information contained within the at least one of the plurality of business models is identified by the difference between the at least one of the plurality of business models and its corresponding reference version.

4. The method of claim 3, further comprising:
replacing, by the computer, the each of the plurality of received reference versions with its corresponding business model after the model mapping has being updated.

5. The method of claim 1, further comprising:
receiving, by the computer, information from an information repository, wherein received the information relates to the changed information contained within the at least one of the plurality of business models.

6. The method of claim 5, wherein the received information is at least one of emails, instant message chats, transcribed meeting notes, any other type of textual communication, or communication that can be converted to a text format where the changed, information contained within the at least one of the plurality of business models is discussed.

7. The method of claim 5, wherein determining, by the computer, how the changed information contained within the at least one of the plurality of business models changes at least one model mapping of the plurality of model mappings is based on the received information and the received at least one model mapping of the plurality of model mappings.

8. The method of claim 1, further comprising:
receiving, by the computer, a reference version for each of the received plurality of business models;
receiving, by the computer, information from an information repository, wherein received the information relates to the changed information contained within the at least one of the plurality of business models;
comparing, by the computer, each of the received plurality of business models with its corresponding received reference version to determine that information contained within at least one of the plurality of business models has been changed; and
wherein the determining, how the changed information contained within the at least one of the plurality of business models changes at least one model mapping of the plurality of model mappings is based on the received information and the received at least one model mapping of the plurality of model mappings.
